(19) United States
(12) Patent Application Publication
(10) Pub. No.: US 2026/0036486 A1
(43) Pub. Date: Feb. 5, 2026

(54) METHOD OF DETERMINING LEAKAGE OF PIPES USING MOVING STANDARD DEVIATION

(71) Applicant: USOL CO., LTD., Daegu (KR)

(72) Inventor: Kwang Suhk Oh, Daejeon (KR)

(21) Appl. No.: 19/257,514

(22) Filed: Jul. 2, 2025

(30) Foreign Application Priority Data
Jul. 31, 2024 (KR) 10-2024-0101966

(51) Int. Cl. G01M 3/28

(52) U.S. Cl. CPC G01M 3/2815

(57) ABSTRACT

The present invention relates to a method of determining leakage of pipes using moving standard deviation and, The method of determining leakage of pipes using moving standard deviation includes: a pressure measurement step of periodically measuring pressure at preset time interval A using a pressure gauge mounted on a pipe; a calculation step of periodically calculating a moving standard deviation using pressure measured in the pressure measurement step at every preset time interval B; and a determination step of determining a state as normal when a moving standard deviation calculated in the calculation step is within a preset error range of a reference standard deviation, or determining that there is leakage in a pipe when the moving standard deviation exceeds the preset error range of the reference standard deviation, wherein a value of the time interval B is greater than a value of the time interval A.

### CROSS REFERENCE TO RELATED APPLICATIONS

The present application claims the benefit of Korean Patent Application No. 10-2024-0101966 filed on Jul. 31, 2024, the contents of which are incorporated herein by reference in their entirety.

### BACKGROUND OF THE INVENTION

### Field of the Invention

The present invention relates to a method of determining leakage of pipes using moving standard deviation and, more particularly, to a method of determining leakage of pipes using moving standard deviation, the method being capable of easily and accurately determining whether leakage occurs in a pipe through which a fluid flows.

### Description of the Related Art

In general, tap water is treated at a water purification plant and then supplied through large pipes to each district in a city. Each district is divided into medium blocks, small blocks, and the like for the supply of tap water.

Further, water meters are installed between distribution points and measure the flow rate of tap water that is supplied to each region.

For large-scale facilities such as apartment complexes, water supply pipes are installed to supply tap water all at once through large pipes.

In densely populated areas such as residential houses and commercial buildings, water is supplied to the points of use by connecting smaller pipes to large pipes buried under roads.

Here, the small pipes are referred to as “branches,” and most leakage occurs in the branches.

That is, branch pipes are narrow enough to have high pressure. Further, branch pipes connected in long distance through joints, etc. in densely populated residential areas, so leakage easily occurs at the junctions and joints.

The total amount of leakage occurring at each of these branch pipes is known that approximately 20% and more of the overall tap water is wasted due to leakage.

Due to such a large amount of leakage, not only does it result in a waste of cost, but it also becomes a cause of water quality contamination, as foreign substances, bacteria, and heavy metals flow into water supply pipes from pressure changes at the leakage points.

In order to address these problems, methods of detecting leakages by sensing vibrations of pipes have been used in the related art.

These methods of detecting leakages by sensing vibrations of pipes are influenced by the type of pipe material, and particularly in the case of plastic pipes, it is difficult to detect leakage due to the short propagation distance of vibrations.

### CITATION LIST

### Patent Literature

Patent Literature 1: Registration No. 10-2418985
Patent Literature 2: Registration No. 10-1876730

### SUMMARY OF THE INVENTION

The present invention has been made to solve the problems described above and an objective of the present invention is to provide a method of determining leakage of pipes using moving standard deviation, the method enabling easy and accurate determination of whether leakage has occurred in pipes regardless of the type of pipe material.

In order to achieve the objective, a method of determining leakage of pipes using moving standard deviation of the present invention includes: a pressure measurement step of periodically measuring pressure at preset time interval A using a pressure gauge mounted on a pipe; a calculation step of periodically calculating a moving standard deviation using pressure measured in the pressure measurement step at every preset time interval B; and a determination step of determining a state as normal when a moving standard deviation calculated in the calculation step is within a preset error range of a reference standard deviation, or determining that there is leakage in a pipe when the moving standard deviation exceeds the preset error range of the reference standard deviation, wherein a value of the time interval B is greater than a value of the time interval A.

Multiple moving standard deviations are calculated in the calculation step, and in the determination step, if there exists zero among the multiple moving standard deviations calculated in the calculation step during a preset time interval C, even if the moving standard deviation calculated in the calculation step exceeds the error range of the reference standard deviation, it is determined that there is no leakage in a pipe, and a value of the time interval C is greater than a value of the time interval B.

The reference standard deviation is an average value of moving standard deviations calculated for each time period during a predetermined number of days, and moving standard deviations and a reference standard deviation are compared for the same time periods in the determination step.

### BRIEF DESCRIPTION OF THE DRAWINGS

FIG. 1 is a flowchart of a method of determining leakage of pipes using moving standard deviation according to an embodiment of the present invention.

FIG. 2 shows test data for describing the method of determining leakage of pipes using moving standard deviation according to an embodiment of the present invention.

### DETAILED DESCRIPTION OF THE PREFERRED EMBODIMENTS

The present invention can be applied to various pipes through which fluids (water, oil, gas, etc.) move, such as water supply pipes, raw water pipes, water transmission pipes, supply pipes, drainage pipes, and gas pipes.

In the present embodiment, the present invention is described by way of example as being applied to water supply pipes, etc.

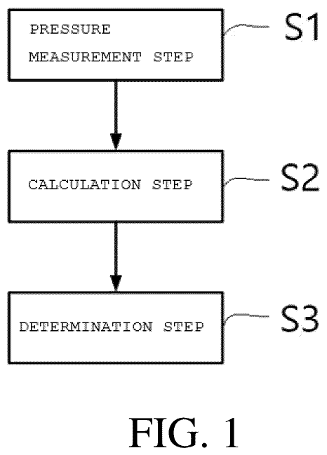

The method of determining leakage of pipes using moving standard deviation of the present invention, as illustrated in FIG. 1, includes a pressure measurement step S1, a calculation step S2, and a determination step S3.

The pressure measurement step S1 is a step of periodically measuring pressure (water pressure) at preset time interval A using a pressure gauge (such as a water pressure gauge) mounted on a pipe through which a fluid such as water flows.

For example, in the pressure measurement step S1, the pressure in a pipe can be periodically measured every 30 seconds.

In this case, the time interval A is 30 seconds.

The calculation step S2 is a step of periodically calculating a moving standard deviation using the pressures measured in the pressure measurement step S1 over a preset time interval B.

A value of the time interval B is greater than a value of the time interval A.

For example, in the calculation step S2, a five-minute moving standard deviation is calculated periodically every five minutes using multiple pressure values measured every 30 seconds in the pressure measurement step S1.

In this case, the time interval B is five minutes.

Since the moving standard deviation is calculated every B time interval in the calculation step S2, the moving standard deviations consist of multiple values.

If the moving standard deviation is 0, it means that there is no leakage nor water usage in the pipe, and if it exceeds 0, it means that there is leakage or water usage in the pipe.

If there is leakage or water usage in a pipe, pressure varies irregularly.

The determination step S3 is a step of determining whether leakage (water leakage) exists in a pipe by using the moving standard deviation calculated in the calculation step S2.

Specifically, the determination step S3 determines that a pipe is normal if the moving standard deviation calculated in the calculation step S2 is within a preset error range of a reference standard deviation, or determines that leakage exists in a pipe if it exceeds the error range of the reference standard deviation.

In this case, the error range of the reference standard deviation is optionally set by the user as necessary.

For example, if the moving standard deviation calculated every 5 minutes is within the preset error range of the reference standard deviation, it is determined that there is no leakage in the pipe at the time when the moving standard deviation was calculated and the state is normal.

Further, if the moving standard deviation calculated every 5 minutes exceeds the error range of the reference standard deviation, it is determined that there is leakage in the pipe at the time when the moving standard deviation was calculated.

In this case, in the determination step S3, if zero exists among multiple moving standard deviations calculated in the calculation step S2 during a preset time interval C, it is determined there is no leakage in the pipe even if a moving standard deviation calculated in the calculation step S2 exceeds the error range of the reference standard deviation.

A value of the time interval C is greater than a value of the time interval B.

For example, if there is even one moving standard deviation of 0 among multiple 5-minute moving standard deviations calculated for one hour, it is determined that there is no leakage in the pipe even if a moving standard deviation calculated for one hour exceeds the error range of the reference standard deviation.

In this case, the time interval C is 1 hour.

A moving standard deviation of 0 means that there is no leakage or water usage. This is because when leakage exists in a pipe, pressure varies very irregularly, so a moving standard deviation of 0 cannot be calculated.

Therefore, if there is even one moving standard deviation of 0 among multiple 5-minute moving standard deviations calculated for one hour, it means that there is no leakage in the pipe for one hour, so it is determined as water usage rather than leakage in the pipe even if a moving standard deviation calculated for one that hour exceeds the error range of the reference standard deviation.

Further, the reference standard deviation may be set as a fixed constant value or as a variable value.

It is preferable that the reference standard deviation is the average value of moving standard deviations calculated for each time period during a predetermined number of days.

In this case, in the determination step S3, the moving standard deviations calculated in the calculation step S2 and the reference standard deviation are compared for the same time periods.

When the reference standard deviation is set as the average value of moving standard deviations calculated for each time period over several preset days as described above, the water usage for each time period each day can be known through the water pressure measured over several days, and using this measured water pressure, the average value of the moving standard deviations, that is, the reference standard deviation, is calculated.

Because the water usage for each time period each day can be known through the water pressure measured over several days, when water usage continuously occurs during a time period when water is normally not used, the moving standard deviation for that time period increases significantly compared to the reference standard deviation.

If the moving standard deviation for a predetermined time period exceeds the error range of the reference standard deviation as described above, it is determined as leakage in the pipe.

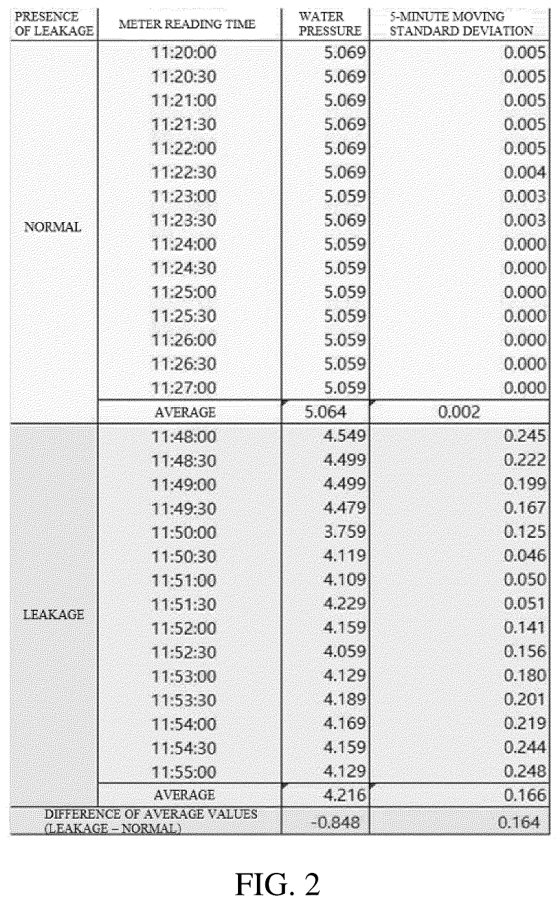

FIG. 2 shows test data for describing the method of determining leakage of pipes using moving standard deviation according to an embodiment of the present invention.

In FIG. 2, the internal water pressure of a pipe was measured every 30 seconds, and a moving standard deviation was periodically calculated every 5 minutes.

In this case, the time interval A is 30 seconds, and the time interval B is 5 minutes.

In a normal state, that is, when there is no leakage, the 5-minute moving standard deviation is between 0.000 and 0.005.

Further, when leakage occurs, the 5-minute moving standard deviation is between 0.046 and 0.248.

Large fluctuations of water pressure with leakage are due to external influences such as vibrations in the surroundings during the pressure measurement.

As can be seen from the data shown in FIG. 2, in the case of leakage, a moving standard deviation increased significantly compared to the normal state.

When the reference standard deviation is set to 0.010, a moving standard deviation smaller than the reference standard deviation is calculated in a normal state, and a moving standard deviation greater than the reference standard deviation is calculated in a leakage state.

Accordingly, it is possible to easily determine whether there is leakage in a pipe.

As described above, since the present invention uses moving standard deviations of the pressure measured by a pressure gauge, it is possible to determine the presence or absence of pipe leakage more accurately than a method that uses a pressure difference (such as water pressure difference) measured by multiple pressure gauges mounted on a pipe.

Further, since the present invention uses moving standard deviations according to the pressure of a pipe, it is possible to perform measurements even at a large distance from a pressure gauge, and there is little influence from the type of pipe material.

The method of determining pipe leakage using the moving standard deviation of the present invention is not limited to the embodiments described above and may be modified in various ways within the allowable range of the spirit of the present invention.

According to the method of determining leakage of pipes using moving standard deviation of the present invention as described above, the following effects can be achieved.

Since the present invention uses moving standard deviations of pressure measured by a pressure gauge, it is possible to determine whether there is leakage in a pipe more accurately than methods that use pressure differences at multiple points of a pipe.

Further, since the present invention uses moving standard deviations according to the pressure of a pipe, it is possible to perform measurements even at a large distance from a pressure gauge, and there is little influence from the type of pipe material.

While the present invention has been described with respect to the specific embodiments, it will be apparent to those skilled in the art that various changes and modifications may be made without departing from the spirit and scope of the invention as defined in the following claims.

What is claimed is:

1. A method of determining leakage of pipes using moving standard deviation, the method comprising:
a pressure measurement step of periodically measuring pressure at preset time interval A using a pressure gauge mounted on a pipe;
a calculation step of periodically calculating a moving standard deviation using pressure measured in the pressure measurement step at every preset time interval B; and
a determination step of determining a state as normal when a moving standard deviation calculated in the calculation step is within a preset error range of a reference standard deviation, or determining that there is leakage in a pipe when the moving standard deviation exceeds the error range of the reference standard deviation,
wherein a value of the time interval B is greater than a value of the time interval A,
multiple moving standard deviations are calculated in the calculation step,
in the determination step, if there exists at least one zero among the multiple moving standard deviations calculated in the calculation step during a preset time interval C, it is determined that there is no leakage in a pipe during the time interval C even if a moving standard deviation calculated in the calculation step during the time interval C exceeds the error range of the reference standard deviation, and
a value of the time interval C is greater than a value of the time interval B.

2. The method according to claim 1, wherein the reference standard deviation is an average value of moving standard deviations calculated for each time period during a predetermined number of days, and
the moving standard deviations and the reference standard deviation are compared for the same time periods in the determination step.
